(19) United States
(12) Patent Application Publication
(10) Pub. No.: US 2002/0052842 A1
(43) Pub. Date: May 2, 2002

(54) Initiation of an electronic payment transaction

(76) Inventors: Marko Schuba, Herzogenrath (DE); Konrad Wrona, Aachen (DE); Guido Zavagli, Tokyo (JP)

Correspondence Address: Spencer C. Patterson, Esq., Jenkens and Gilchrist, P.C., 3200 Fountain Place, 1445 Ross Ave., Dallas, TX, 75202, US

(21) Appl. No.: 09/935,539

(22) Filed: Aug. 23, 2001

(30) Foreign Application Priority Data
Aug. 25, 2000 (EP) 00118543.8

(51) Int. Cl. G06F 17/60

(52) U.S. Cl. 705/40; 705/39

(57) ABSTRACT

The invention relates to a method for initiating an electronic payment transaction. A filter FI receives a payment request 300 and modifies it by adding a transaction identification. It sends the modified payment request 301 to a transaction server WS, and a payment request information 302 containing the transaction identification to a communication terminal MS. The transaction server WS receives the modified payment request 301 and a payment initiation 303 containing an additional transaction identification from the communication terminal MS. The transaction server WS compares the transaction identifications of the modified payment request 301 and the payment initiation 303 and performs the payment transaction 304, if the transaction identifications correspond with each other. The invention moreover relates to a corresponding filter FI and a transaction server WS, to a method for initiating the filter FI and to a computer program for initiating an electronic payment transaction and for initiating the filter FI.

### FIELD OF THE INVENTION

The invention relates to electronic payment transactions. In particular the invention relates to a method and a computer program for initiating an electronic payment transaction, to a filter and a transaction server of a communication system, by means of which the electronic payment transaction is initiated and respectively implemented, as well as to a method and a computer program for initiating the filter.

### BACKGROUND OF THE INVENTION

The increasing propagation of mobile communication means for the voice and data transmission creates the need for mobile services in the field of electronic business transactions, in other words, services like electronic payments, ticket orders or home banking with mobile communication means. For this purpose the payments systems may be integrated in mobile communication systems. Such mobile communication systems are, for example, a Global System for Mobile Communication (GSM), a GSM system offering a General Packet Radio Service (GPRS), a Packet Personal Digital Cellular (PPDC) System, a Wideband Code Division Multiple Access (WCDMA) System, a Universal Mobile Telecommunication System (UMTS), a Bluetooth™ System, a Digital European Cordless Telecommunications (DECT) System or wireless Local Area Network (LAN) systems or respectively wireless Asynchronous Transfer Mode (ATM) Systems.

One known protocol for electronic payment transactions is the Secure Electronic Transaction (SET™) protocol, which allows a credit card holder by means of a terminal, e.g. a personal computer (PC), the safe electronic payment via a public network, such as the internet. The encryption algorithms used by the SET™ set a high standard on the processor performance and the memory space of the terminal. Mobile communication means, such as mobile phones, can frequently not meet said demands. Therefore, SET™ is not suited as protocol for electronic payment transactions via mobile communication terminals in an implementation provided for the PC.

Two concepts relating to an implementation of the SET™ protocol for the electronic payment by means of mobile communication terminals are proposed in the article “Adaptation of the SET Protocol to Mobile Networks and to the Wireless Application Protocol”, Proceedings of European Wireless '99, 1999, pages 193-198, VDE-Verlag Berlin, by K. Wrona and G. Zavagli. In one concept, payment transactions are performed by a SET™ Wallet Server being, for instance, part of a mobile communication system, rather than by the mobile communication terminal. The SET™ Wallet Server thereby contains the entire SET™ functionality. The keys used for encrypting by the SET protocol, a public and a private key of the customer, i.e. the user of the communication terminal, are stored in the SET™ Wallet Server.

A Split SET™ Server is proposed in another concept. Just like the SET™ Wallet Server, the Split SET™ Server rather than the mobile communication terminal performs payment transactions by means of the SET™ protocol. For this purpose, the Split SET™ Server contains the public key of the customer. The private key of the customer is stored in the mobile communication terminal, e.g. in a subscriber identity module (SIM) card of the terminal or in another smart card.

For the communication with the SET™ server and a server of a merchant, the Hypertext Transfer Protocol HTTP and the use of Java are suggested. For the communication with a Wireless Application Protocol (WAP) phone a WAP Proxy Gateway translates between the HTTP protocol and the WAP protocol.

In both concepts described, payment transactions are triggered by payment requests sent from a server of a merchant to the communication terminal of the customer. For the electronic payment the communication terminal must be capable of processing the respective payment request, irrespective of the size of the message, the content thereof or the used transmission protocol. This involves considerable effort and costs, as sufficient resources, i.e. processing and storing capacities, have to be available in the communication terminal.

The use of a WAP Proxy Gateway does not solve this problem. If, for instance, a payment request, which can be sent off by a server of the merchant in the form of a HTTP message, exceeds the allowed WML page size after the translation into the WML format, it can no longer be represented in the communication terminal.

In the article “Mobile Chip Electronic Commerce: Enabling Credit Card Payment for Mobile Devices”, Proceedings of eBiz2000, June 2000, Singapore, by M. Schuba and K. Wrona the Mobile Chip Electronic Commerce concept is introduced, which splits the client functionality of the SET™ protocol into a client functionality in a mobile communication terminal and into a server functionality in a Mobile Chip Electronic Commerce Server. The electronic payment transaction is initiated by a payment request sent by the server of the merchant to the mobile terminal of the customer. The payment request contains the amount to be paid, a currency, information on credit cards accepted by the merchant, an address of the merchant as well as details of the placed order. The mobile communication terminal thereupon transmits a payment initiation to the Mobile Chip Electronic Commerce Server. Apart from data contained in the payment request the payment initiation contains a credit card type, an expiry date of the credit card and an account number. Upon the receipt of the payment initiation the Mobile Chip Electronic Commerce Server performs an exchange of messages with the server of the merchant required for the payment by means of the SET™ protocol, as well as an exchange of messages with the communication terminal for authentication purposes and for confirming the payment.

Just like with the SET™ Wallet Server concept and the Split SET™ Server concept, the Mobile Chip Electronic Commerce concept embodies the disadvantage that for initiating the electronic payment transaction the communication terminal has to process the payment request, irrespective of the size thereof, the content or the used transmission protocol, and that it has to have the resources required therefor available.

As an alternative it is conceivable that the server of the merchant knows the capabilities of the communication terminal and correspondingly adopts the payment request in view of its size, content and the used transmission protocol. This, however, requires considerable activities, for instance, in view of the necessary signaling of the present processing capacities. The efficiency of the payments system is, moreover, limited, if the compatibility with old or low performance devices with respect to the communication terminals is guaranteed.

### OBJECT OF THE INVENTION

It is the object of the present invention to improve electronic payment transactions, especially via mobile communication terminals, so as to ensure a reliable payment handling, irrespective of the efficiency of the terminal.

### SUMMARY OF THE INVENTION

In accordance with the invention said object is provided by the teaching of the independent claims 1, 7, 9, 14 and 16.

Claim 1 describes a method for initiating an electronic payment transaction, claim 9 describes a filter of a communication system and claim 14 describes a transaction server.

Involved in an initiation of an electronic payment transaction are a server of a merchant, a communication terminal of a customer, a transaction server and a filter. Each supplier of goods or services can be a merchant. The filter forms part of a communication system. The communication system allows a communication between the server of the merchant, the communication terminal and the transaction server. The entire communication preferably takes place via the filter. The filter has, among others, the task of forwarding certain messages concerning the electronic payment transaction to assigned receivers.

The transaction server, which may be a SET™ Wallet Server, a Split SET™ Server or a Mobile Chip Electronic Commerce Server, comprises a software, e.g. according to the SET™ protocol, for implementing an electronic payment transaction at the expense of the customer. The transaction server preferably takes charge of calculation and memory space intensive process steps of the payment transaction. The communication terminal is not burdened with the processing of said process steps. The payment transaction requested by the server of the merchant is merely confirmed by the communication terminal of the customer, e.g. a mobile phone or an electronic wallet.

In the following the message flow for initiating an electronic payment transaction will be explained in more detail. The server of the merchant requests an electronic payment by means of a payment request. The request is effected, for instance, after a customer has placed an order via the internet by means of the communication terminal. Apart from an amount to be paid, a currency, information on the credit cards accepted by the merchant and an address of the merchant the payment request can contain details of the order placed, e.g. a list of the ordered goods or services. Also a prepared sales contract or the general terms and conditions of trade from the merchant may be part of the payment request. Advantageously there is no limitation to the size for the payment request. In an embodiment of the invention the payment request is addressed to the filter, i.e. the filter address is known to the server of the merchant in this case. The filter address may have been imparted to the server of the merchant, for instance, during the ordering process by the client, or it may be stored in the server of the merchant as part of the customers' data.

The filter receives and modifies the payment request by adding a transaction identification, which may, for instance, be a numerical value, and sends the modified payment request to the transaction server. The address of the transaction server may be fixedly stored in the filter. The filter sends a payment request information containing the transaction ID to the communication terminal of the customer. The address of the communication terminal is known to the filter, for example, from the payment request.

The payment request, which in the case of an extensive purchase may contain a plurality of data, is advantageously not sent to the communication terminal of the customer, which may be limited in view of the processing capacity of the processor and in view of the available memory space, but is sent to the transaction server having sufficient processor performance and sufficient storage capacity for processing extensive payment requests. Furthermore it is advantageous that the air interface of the mobile radio system to the communication terminal is not burdened by the transmission of the payment request, which contains a large quantity of data. Delay times occurring on the air interface when the payment request is transmitted in a system with a low transmission rate, which reduce the acceptance of electronic payment transactions on the customer's side, are avoided.

The payment request information sent by the filter to the communication terminal preferably contains an essentially smaller quantity of data than the payment request. In the simplest case the payment request information consists of the transaction ID. The payment request information can also be rapidly transmitted to the communication terminal of the customer by mobile radio systems having a small data rate on the air interface. The small size of the payment request information renders the transmission thereof flexible with respect to the used transmission mechanism. It can, for example, be transmitted via a circuit-switched or a packet-oriented data connection, via the Short Message Service (SMS) or via the Unstructured Supplementary Service Data (USS). As additional protocol based on the aforementioned or other transport protocols, WAP may advantageously be used.

Upon the receipt of the payment request information the communication terminal sends a payment initiation to the transaction server, the address of which may be stored in the communication terminal or may be entered by the customer. The sending of the payment initiation may take place automatically upon the receipt of the payment request information, for example, in a WAP session set up by the communication terminal to the transaction server. The payment initiation constitutes a confirmation for the transaction server to perform the payment transaction. It contains the transaction ID of the payment request information. The payment initiation can be transmitted by means of the same mechanisms like the payment request information.

The transaction server receives the modified payment request from the filter and the payment initiation from the communication terminal. As soon as these two messages are available, it compares the transaction IDs thereof. If the transaction IDs correspond with each other, the transaction server performs the payment transaction, e.g. by means of the mechanisms of the SET™ protocol. By comparing the transaction IDs the transaction server can make sure in an easy manner that the payment is authorized by the customer, i.e. that it is enabled. Apart from the transaction server and the server of the merchant, another server, e.g. also a bank server of a credit institute, may by involved in the performance of the payment.

The filter comprises an input interface for receiving the payment request, an output interface for sending the modified payment request and the payment request information, as well as a computer unit for identifying and modifying the payment request. The computer unit may be a hardware, e.g. a processor, or a software, e.g. a virtual machine.

The transaction server comprises an input interface for receiving the modified payment request and the payment initiation, a computer unit for comparing the transaction IDs of the modified payment request and the payment initiation, as well as an output interface, via which the computer unit performs the payment transaction given that the transaction IDs correspond with each other. The computer unit may advantageously comprise a memory, which can store a message, i.e. the modified payment request or the payment initiation, for example the message received first, or both messages.

The invention permits the use of complex and secure protocols, e.g. the SET™ protocol, for implementing electronic payment transactions with high demands on the computing capacity and the memory space, for mobile communication terminals having limited resources.

The invention is moreover advantageous, when the communication between the server of the merchant and the communication terminal takes place by means of a communication session, e.g. a WAP session, which does not admit any other session subscriber as communication partner, e.g. the transaction server, or which is interrupted or terminated by a message from another communication partner, e.g. the transaction server. The invention allows the maintenance of the communication session between the server of the merchant and the communication terminal also during the performance of the electronic payment transaction by means of the transaction server, as said transaction server is integrated by the filter in the existing communication session in view of the message flow.

Independent claim 7 describes the initiation of a filter of a communication system. The filter requires an address of a transaction server so as to be capable of forwarding received payment requests. For this purpose the transaction server receives a filter initiation request, which is, for example, sent by a communication terminal and which prompts the transaction server to send a filter initiation message containing the address of the transaction server to the filter. The filter initiation message is received by the filter of the communication system, and the contained address is stored in the filter.

The initiation of the filter is flexible, in other words, it may take place at any optional time, for example, prior to each sending of a payment request or in the first or each registration of a communication terminal in the communication system. It allows an easy change of the address of the transaction server. The filter initiation is especially advantageous, if several transaction servers for performing payment transactions are available. The filter initiation message may then indicate the transaction server being competent for a certain customer, i.e. the transaction server administering a corresponding customer account.

The invention may advantageously be realized as a computer program, which allows the use of the invention in terminals without requiring changes to the hardware. Furthermore, the computer program allows within the scope of manufacturing processes the easy and inexpensive performance of tests and simulations.

Additional advantageous embodiments and improvements of the invention can be inferred from the dependent claims 2 to 6, 8, 10 to 13, 15 and 17.

According to claim 2 the transaction ID is a random number. According to claim 10 the determination of the random number is effected by a random sequence generator of the filter, for instance, by means of a mathematical random function. The random character of the transaction ID can prevent manipulations of unauthorized persons using, for instance, falsified payment initiations. In another embodiment of the invention the determined transaction ID is unique, at least within a certain period of time. This may be ensured, if the filter stores all transaction IDs determined in said period of time. Upon the determination of an additional transaction ID and prior to a use of said additional transaction ID the filter makes sure by means of a memory inquiry that the additional transaction ID does not correspond to any of the stored transactions IDs. The uniqueness of the used transaction ID constitutes a protection against confusions in the assignment of the modified payment request and payment initiation performed by the transaction server.

According to claim 3 the payment request is destined for the communication terminal, i.e. it is addressed to the communication terminal. The filter being disposed on the transmission path between the server of the merchant and the communication terminal recognizes, when checking a received message, by means of a first identifier identifying the message type, e.g. when a HTML message format is used by means of the content type such as “application/payment request”, that a payment request is concerned. The filter intercepts said message, i.e. it is not forwarded to the communication terminal, but is further processed, as is indicated in claim 1. Thus, the filter is transparent, i.e. invisible to the server of the merchant. The server of the merchant does not have to address the payment request to the filter and, therefore, does not require an address of the filter. Therefore, an operator of the communication system may easily perform reconfigurations like exchanging the filter or changing the filter address, for instance for maintaining the system, without the server of the merchant noticing them.

According to claim 11 the check, whether the payment request contains the first identifier, and the interception take place by means of the computer unit of the filter.

The embodiments described in claims 4, 12 and 15 permit an advantageous initiation of the filter.

According to claims 5, 8 and 13 the filter initiation message is recognized by the filter by means of an identifier and is intercepted. When using the HTTP message format, the identifier may be a content type, e.g. “application/filter initiation”. The filter address is thereby advantageously not required for initiating the filter initiation. For addressing the filter initiation message any address may be used, if all messages sent by the transaction server are transmitted via the filter of the communication system. The filter initiation message can, for example, be addressed to the communication terminal.

According to claim 6 and claim 15 the transaction server sends a corresponding filter initiation to the filter upon receipt of a filter initiation request sent by the communication terminal. In the simplest case the filter initiation request contains an ID prompting the transaction server to send off the filter initiation. The ID may be a content type, e.g. “application/filterinit request”. The filter is advantageously not visible to the communication terminal. Said kind of filter initiation serves the safety against manipulation attempts by others. The filter can, for example, be adjusted so as to accept no initiation messages from communication terminals, but only from certain transaction servers.

According to claim 17 is computer program is stored on a computer-readable medium. This allows, for instance when using floppy discs or CD Roms, an easy portability of the computer program and thereby the easy application of the invention in different devices, such as on test systems, simulation systems or machines for the production of terminals.

In the following the invention will be explained in more detail by means of embodiments and figures.

### BRIEF DESCRIPTION OF THE FIGURES

FIG. 1 shows a system for electronic payment transactions,

FIG. 2 shows another system for electronic payment transactions,

FIG. 3 shows a message flow between elements of a system for electronic payment transactions for initiating a payment transaction,

FIG. 4 shows a message flow for initiating a filter of a system for electronic payment transactions.

### DESCRIPTION OF THE EMBODIMENTS

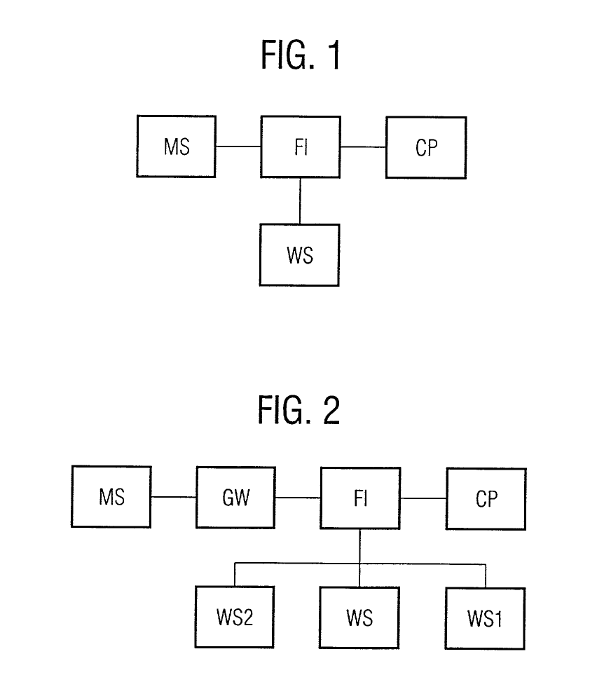

FIG. 1 shows in a simplified illustration a system for electronic payment transactions. It comprises a server CP of a merchant, a filter FI, a transaction server WS and a communication terminal MS. The filter FI is logically connected with all illustrated components. The entire message flow between the server CP of the merchant and the communication terminal MS in the indicated embodiment is effected via filter FI.

The communication terminal MS is preferably a mobile terminal, e.g. a mobile phone, preferably a WAP phone, a laptop or a Personal Digital Assistant PDA. The filter FI is part of a communication system, such as a GSM, GPRS, PPDC, WCDMA, UMTS, Bluetooth™, DECT, a wireless LAN or a wireless ATM system. The communication between the communication terminal and the filter takes place via an infrastructure of the communication system not shown in the figure, for instance, via base stations and switching centers. The filter FI, the server CP of the merchant and the transaction server WS may each form part of a packet-switched network, such as the internet. Alternatively, the server CP of the merchant or the transaction server WS may be connected with the filter FI via an auto-dial connection or via a fixed line. According to another embodiment the filter FI and the transaction server WS may be combined in a node of the communication system. Both can be controlled by a mutual software program.

The server CP of the merchant is preferably an internet server offering the buying of goods or services on HTML or WML pages. A software in the communication terminal MS, e.g. a HTML viewer, allows the customer to make a selection of the desired products and to place an order. Both, customers' data and software can be provided on a SIM card of the communication terminal.

After an order has taken place, the payment is effected by means of a payment transaction, which is performed by the transaction server WS. For this purpose the transaction server WS may comprise a data base with a corresponding customer account. The filter FI allows among others, that certain messages be redirected to the transaction server for the communication terminal.

The payment transaction is preferably performed by means of the SET™ protocol being implemented in the transaction server WS and in the server CP of the merchant. The servers WS, CP can, for example, perform the encryption and authentication steps required for the use of the SET™ protocol. In dependence on the used protocol, the electronic payment may involve additional nodes not shown in the figure, e.g. a server or a gateway of a credit institute.

FIG. 2 shows in a simplified illustration another system for electronic payment transactions. In the following only components and functions will be explained, which were not explained in connection with FIG. 1. The system additionally comprises a gateway GW between the communication terminal MS and the filter FI, which serves the protocol conversion. The communication between the server CP of the merchant, the filter FI, the transaction server WS and the gateway GW preferably takes place by means of the HTTP protocol. The communication terminal in contrast uses, for example, WAP as higher transmission protocol. The gateway GW carries out the translation between the protocols.

The system for electronic payment transactions shown in FIG. 2 moreover comprises several transaction servers WS, WS1, WS2. Several credit card institutes can, for instance, each operate their own transaction server WS, WS1, WS2. Payment transactions of a customer having more than just one credit card may be performed by means of different transaction servers WS, WS1, WS2 depending on the credit card selected for the payment. The use of several transaction servers WS, WS1, WS2 can also serve the traffic load distribution or capacity extension.

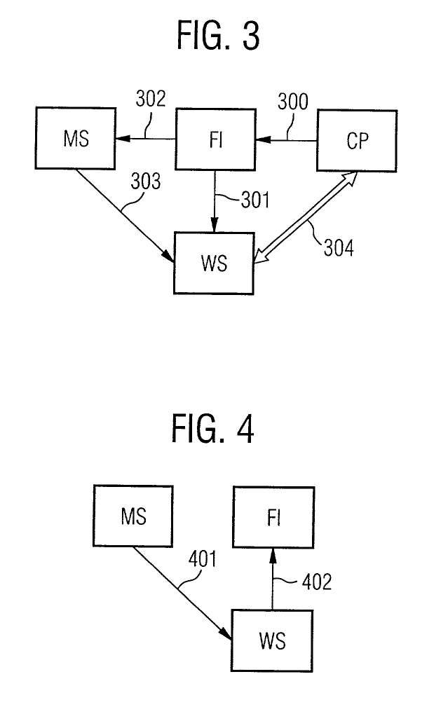

FIG. 3 shows an exchange of messages between components of a system for electronic payment transactions. Illustrated is the information flow between a server CP of a merchant, a filter FI, a transaction server WS and a communication terminal MS. After, for example, an ordering process by a customer with a merchant has been effected, an electronic payment transaction is initiated. For this purpose the server CP of the merchant sends a payment request 300 to the communication terminal MS of the customer. The payment request, for instance, contains the invoiced amount to be paid, a currency, information on accepted credit cards or a banking connection of the merchant, an address of the merchant as well as details on the placed order. Furthermore, the payment request 300 contains a first identifier identifying it as a message of the type “payment request”, e.g. a content type “application/payment request” when the HTTP protocol is used. The filter FI examines all received messages for such an identifier. Messages containing said identifier are not forwarded to the originally destined addressee, but are intercepted. The payment request 300 illustrated in FIG. 3 contains said first identifier, and it is, therefore, not forwarded to the communication terminal MS.

Instead the filter FI modifies the payment request 300 by adding a transaction ID. The filter sends the modified payment request 301 to the transaction server WS. The address of the transaction server WS is either fixedly stored in the filter, e.g. in a ROM memory, or it is communicated to the filter during a filter initiation, as will be explained later.

In another embodiment the transaction ID to be used for the modification of the payment request is communicated to the filter FI by the communication terminal MS, for instance, after an order for goods or services has been placed in the server CP of the merchant. Thus, it can be assured that the filter processes payment requests from the server of the merchant only when it has been provided with the transaction ID assigned by the communication terminal. This safety feature makes sure that the filter does not process any unexpected payment requests. Moreover, a certain time of validity can be allocated to the communicated transaction ID so as to prevent that it will erroneously be used for initiating a later payment transaction in case the server CP of the merchant does not send a payment request. The filter FI furthermore sends a payment request information 302 to the communication terminal MS. The payment request information 302 contains essentially the same transaction ID by means of which the payment request 300 was modified. The communication terminal reacts—either automatically or upon the user's wish—with sending off a payment initiation 303 to the transaction server WS. The payment initiation 303 contains the transaction number, which was contained in the payment request information 301.

The transaction server compares for the received modified payment information 301 and for the received payment initiation 302 the transaction IDs thereof. In the illustrated embodiment an identity corresponds to a confirmation of the payment, and the transaction server WS performs the payment transaction 304 by a communication with the server CP of the merchant. In dependence on the used protocol for performing the electronic payment, the illustrated payment transaction 304 may comprise a plurality of messages, which are exchanged between the transaction server WS and the server CP of the merchant, or it may include another instance, e.g. a server of a credit institute.

FIG. 4 shows a message flow for initiating a filter FI of a system for electronic payment transactions. Filter initiation means that an address of a receiver, e.g. of a transaction server MS, is communicated to the filter FI, whereby the receiver receives and processes one or more specific message types, e.g. a payment request, on behalf of a certain communication terminal MS or a certain customer, i.e. it carries out, for example, an electronic payment transaction. In another embodiment of the invention the filter is being communicated during the initiation the message types, to which this is to apply. Furthermore, processing rules for messages of a certain type can be sent to the filter during the initiation, e.g. for the modification of messages of said type.

The example shown in FIG. 4 shows a filter initiation request 401 sent by a communication terminal MS to a transaction server WS. In order to enable a redirection of a payment request 300 destined for the communication terminal MS from the filter FI to the transaction server WS, the transaction server WS sends its address to the filter FI by means of a filter initiation message 402.

In additional embodiments of the invention the messages illustrated in FIGS. 3 and 4 each represent a message bundle, which may comprise messages for the confirmation, authentication or encryption.

Another embodiment of the present invention relates to a computer program. The computer program, which can be loaded in an internal memory of a digital computer unit, especially of a communication terminal, comprises software code parts being suited to perform the method according to the invention when the computer program is executed on the computer unit.

Said computer program can especially also be stored on a computer-readable medium, such as a floppy disc, a CD-ROM or an optical disk.

1. Method for initiating an electronic payment transaction comprising the following steps:
receiving a payment request (300) by a filter (FI) of a communication system,
modifying the payment request (300) by adding a transaction identification,
transmitting the modified payment request (301) to a transaction server (WS),
transmitting a payment request information (302) containing the transaction identification from the filter (FI) to a communication terminal (MS),
transmitting a payment initiation (303) containing an additional transaction identification from the communication terminal (MS) to the transaction server (WS),
comparing the transaction identifications of the modified payment request (301) and the payment initiation (303) by the transaction server (WS),
performing the payment transaction (304) by the transaction server (WS) if the transaction identifications correspond with each other.

2. Method according to claim 1, wherein the transaction identification is a random number.

3. Method according to claim 1 or 2, wherein the payment request (300) is destined for the communication terminal (MS) and is recognized by the filter (FI) by means of a first identifier and is intercepted.

4. Method according to claim 1, 2 or 3, wherein the filter (FI) receives and stores a filter initiation message (402) containing an address of a transaction server (WS), and wherein the filter (FI) sends the modified payment request (301) by means of the stored address.

5. Method according to claim 4, wherein the filter (FI) recognizes the filter initiation message (402) by means of a second identifier and intercepts it.

6. Method according to one of claims 1 to 5, wherein the transaction server (WS) sends the filter initiation message (402) upon receipt of a filter initiation request (401).

7. Method for initiating a filter (FI) of a communication terminal, wherein a transaction server (WS) receives a filter initiation request (401), wherein the transaction server (WS) sends a filter initiation message (402) containing an address identifying the transaction server (WS), and wherein the filter (FI) receives the filter initiation message (402) and stores the address.

8. Method according to claim 7, wherein the filter (FI) recognizes the filter initiation message (402) by means of an identifier and intercepts it.

9. Filter for a communication system, comprising
an input interface for receiving a payment request (300),
a computer unit for the identification of the payment request (300) and for the modification by adding a transaction identification,
an output interface for sending the modified payment request (301) to a transaction server (WS) and for sending a payment request information (302) containing the transaction identification to a communication terminal (MS).

10. Filter according to claim 9 comprising a random sequence generator determining a random number as the transaction identification.

11. Filter according to claim 9 or 10, wherein the computer unit checks the presence of a first identifier in the payment request (300) and intercepts the payment request (300).

12. Filter according to claim 9, 10 or 11, which receives via the input interface and stores in a memory a filter initiation message (402), that contains an address of the transaction server (WS), and wherein the modified payment request (301) sends by means of the stored address.

13. Filter according to one of claims 9 to 12 recognizing the filter initiation message (402) by means of the second identifier and intercepting it.

14. Transaction server, comprising
an input interface for receiving a modified payment request (301) containing a first transaction identification, and for receiving a payment initiation (303) containing a second transaction identification,
a computer unit for comparing the transaction identifications of the modified payment request (301) and the payment initiation (303), and
an output interface, via which the computer unit performs a payment transaction (304) if the transaction identifications correspond with each other.

15. Transaction server (WS) according to claim 14, sending a filter initiation message (402) upon receipt of a filter initiation request (401).

16. Computer program, which can be loaded into an internal memory of a digital computer unit, and which comprises software code parts being suited to perform the steps according to one of claims 1 to 8 if the computer program is executed on the computer unit.

17. Computer program according to claim 16, wherein the computer program is stored on a computer-readable medium.
